(19) United States
(12) Patent Application Publication
(10) Pub. No.: US 2012/0307952 A1
(43) Pub. Date: Dec. 6, 2012

(54) NEUTRON DETECTOR

(76) Inventor: Taylor Ramon WILSON, Texarkana, AR (US)

(21) Appl. No.: 13/467,740

(22) Filed: May 9, 2012

Related U.S. Application Data
(60) Provisional application No. 61/483,897, filed on May 9, 2011.

(51) Int. Cl. G01T 3/00

(52) U.S. Cl. 376/153

(57) ABSTRACT

The Cherenkov effect is used to detect neutrons emitted by man-made radioactive materials. Water or other liquid or gas may be used as a detection medium. The water may include a dispersed or dissolved dopant having a high neutron capture cross-section, which renders the dopant able to absorb and react with neutron radiation effectively. When the dopant absorbs, or reacts with, a neutron particle, the result of the reaction may be the generation of beta particles which can be detected via the accompanying emission of light, dispersed or dissolved, according to the Cherenkov effect.

This application claims priority from U.S. Provisional Patent Application No. 61/483,897 titled “Neutron Detector,” filed on May 9, 2011, which is incorporated herein by reference in its entirety.

### BACKGROUND OF THE INVENTION

1. Field of Invention

Aspects of the present invention relate to a detector for radioactive material. More specifically, aspects of the present invention relate to a neutron detector for detecting neutrons emitted by man-made or other radioactive material.

2. Description of Related Art

There are known systems used to detect man-made or other radioactive material. These known systems, however, are typically based on gas-proportional detectors having about one atmosphere of an isotope gas such as a Helium-3 isotope gas. Current cargo scanning systems that are used for monitoring the presence of radioactive material such as, for example, plutonium in cargo (transported by e.g., air, ship or land) are set up to use Helium-3 neutron detectors. In a typical system, two electrodes—an anode and a cathode—are positioned inside a Helium-3 gas-filled tube, and when Helium-3 absorbs a neutron that has been emitted by man-made radioactive material, the absorption, which is in fact a reaction between the Helium-3 and the neutrons, creates an electric breakdown, which causes a signal to be generated between the two electrodes. The signal is sent to a detector, indicating the presence of radioactive material. However, there is a critical shortage of the Helium-3 isotope, which is the material that is typically used for such applications. This isotope is not found in large quantities anywhere in the world. Besides, Helium-3 must be extracted from a decay reaction of Tritium (H³). As such, due to the large demand for highly efficient neutron detectors utilizing this isotope, which are used in neutron portal monitors for the detection of weapons-grade Plutonium, there are critical supply shortages of Helium-3.

Accordingly, there is a critical need for neutron and gamma detectors that do not utilize Helium-3, but that are alternative systems that produce results of a comparable quality to the results produced by Helium-3 based systems. While some alternatives already exist, they generally do not duplicate the sensitivity and/or efficiency of Helium-3 based systems.

### SUMMARY OF THE INVENTION

In light of the above described problems and unmet needs, systems and methods are provided that utilize either photodiodes or photomultiplier tubes to detect light generated by the capture reaction between a high neutron capture cross-section element and a neutron emitted by a man-made radioactive element, instead of the more rare and more expensive Helium-3.

Weapons-grade plutonium, which is a man-made radioactive element, contains a plutonium Pu-240 contaminant, which is generated during the production of plutonium, and which emits neutrons. In addition, Cherenkov radiation is an electromagnetic radiation emitted when a charged particle passes through a dielectric medium at a speed greater than the phase velocity of light in that medium. The charged particles polarize the molecules of that medium and excits the molecules, and when the molecules fall back rapidly to their original or ground state, radiation is emitted in the process. For example, the characteristic blue glow of nuclear reactors is due to Cherenkov radiation. Cherenkov detectors typically rely on a simple detection medium such as water or a rarefied gas, but the high efficiency of this phenomenon allows for a wide range of uses. For example, Cherenkov detectors can be used by exploiting the concept of “neutron tagging” by utilizing a dopant to tag unwanted neutrons.

According to various aspects of the current invention, the Cherenkov effect may be used to detect neutrons emitted by man-made radioactive materials, and water or other suitable liquid or gas may be used as a detection medium, where the water may include a dispersed or dissolved dopant having a high neutron capture cross-section, which renders the dopant able to absorb and react with neutron radiation very effectively. For example, glasses or noble gases such as Xenon, Argon and Helium, at atmospheric pressure or under high pressure, may also be used as a detection medium. According to various aspects, for the noble gases, the Cherenkov effect may be used in conjunction with the intrinsic scintillation properties of the gases. In such a design, the walls of the reaction chamber may be coated with a Gadolinium/Boron-10 mixture, and constructed of a chamber that could contain high pressures of about 500-1000 PSI. According to various aspects, for liquid or solid Cherenkov media, the conversion dopant may be homogeneously spread throughout the medium. When the dopant absorbs, or reacts with, a neutron particle, the result of the reaction may be the generation of beta particles that can be detected via the accompanying emission of light, dispersed or dissolved, according to the Cherenkov effect.

According to various aspects, a combination of medium and dopant may be, for example, i) a combination of water and GdCl₃ (Gadolinium chloride), ii) sapphire (aluminum oxide Al₂O₃), or iii) beryl (or beryllium aluminium cyclosilicate, Be₃Al₂(SiO₃)₆). Gadolinium Chloride is a colorless, hygroscopic, water-soluble solid. In sapphire, aluminum, being part of the sapphire crystalline structure, fulfills the same role of the GdCl₃ dopant in water, with the added advantage that aluminum is actually part of the crystalline structure of sapphire, which eliminates the need for an additional step of doping sapphire. With respect to beryl, the fact that beryllium is part of the crystalline structure of beryl fulfills the same role as the GdCl₃ dopant in water and also eliminates the need for an additional step of doping beryl. A common aspect of Gadolinium, Aluminum and Beryllium is that each has a high neutron capture cross-section. In other words, each has the ability to react with a large number of emitted neutrons. When Gadolinium, Aluminum of Beryllium absorbs the neutron, a reaction takes place that generates light, and the light can be detected. In the specific case of Gadolinium, the reaction with a neutron in water emits a beta particle, and the water detects the beta particle by emitting light.

Additional advantages and novel features of aspects of the present invention will be set forth in part in the description that follows, and in part will become more apparent to those skilled in the art upon examination of the following or upon learning by practice of the invention.

### BRIEF DESCRIPTION OF THE DRAWINGS

Various exemplary aspects of the systems and methods will be described in detail, with reference to the following figures, wherein:

FIG. 1 is an illustration of a Gadolinium-based neutron detector system, according to various aspects of the current invention;

FIG. 2 is an illustration of a neutron detection process using a Gadolinium-based neutron detector, according to various aspects of the current invention;

FIG. 3 presents an exemplary system diagram of various hardware components and other features, for use in accordance with an aspect of the present invention; and

FIG. 4 is a block diagram of various exemplary system components, in accordance with an aspect of the present invention.

### DETAILED DESCRIPTION OF PREFERRED ASPECTS

These and other features and advantages of this invention are described in, or are apparent from, the following detailed description of various exemplary aspects.

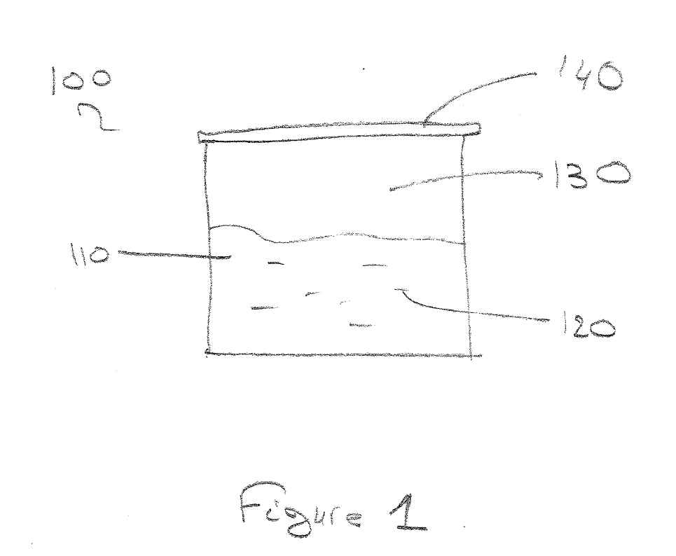

FIG. 1 is an illustration of a Gadolinium-based neutron detector system, according to various aspects of the current invention. In FIG. 1, the container 100 includes a fluid 110 such as, for example, deionized water, which is capable of detecting beta particles, and a dopant 120 such as, for example, Gadolinium Chloride (GdCl₃), which dissolved or dispersed in the fluid 110. According to various aspects, when the container is metal or metallic and may be subjected to corrosion, the container may also contain an inert gas 130 such as, for example, argon (Ar), in order to prevent the occurrence of corrosion reactions, the result of which could potentially be a decrease in the neutron capture cross-section of the dopant 120. The container 100 may be sealed via a seal 140 in such as way as to prevent any reactive gas such as, for example, oxygen, from penetrating inside the container 100 and corroding the inside surface of the container 100. As an additional precaution against corrosion, the inside surface of the container 100 may be coated with an insulating layer via, for example, painting. The color of the insulating layer painted on the inside surface may also be chosen so as to improve reflectivity of emitted photons.

According to various aspects of the current invention, the dopant 120 may have several qualities, including, for example: i) having a high neutron-capture cross-section, which is a measure of a probability of absorbing a neutron, typically in the order of about a few thousand barns, e.g., 50,000 barns for Gadolinium; and ii) the result of the neutron capture reaction should be detectable.

According to various aspects, the container 100 may be a steel drum such as, for example, a five-gallon steel drum. The interior surface of the five gallon steel drum 100 may be painted with water resistant white paint, for example. Alternatively, a non-metallic container 100 may also be used, as long as the non-metallic container is opaque to light. Also, one or more photomultiplier tubes (PMTs) or photodiodes may be connected in series during neutron emission to detect the neutron emission. Accordingly, any light leaks that may be present in the container may be mitigated or blocked by the white paint. According to various aspects, deionized water 110 may be used as the detection medium in order to decrease or eliminate contaminates that could possibly degrade the detected signal, and GdCl₃ may be used as the dopant 120 because of its high solubility, low environmental toxicity, and low reactivity with other metals and compounds. For example, the dopant 120 may be relatively inert with respect to other metals and compounds. According to various aspects, a solution of 0.1% GdCl₃ by weight in water may be used, which represents about 15 (14.98) grams of GdCl₃. After the GdCl₃ 120 is dissolved in the deionized water 110, the container 100 may be filled with an inert gas 130 such as Argon, in order to reduce oxidation of the metal. The container may then be sealed by the seal 140.

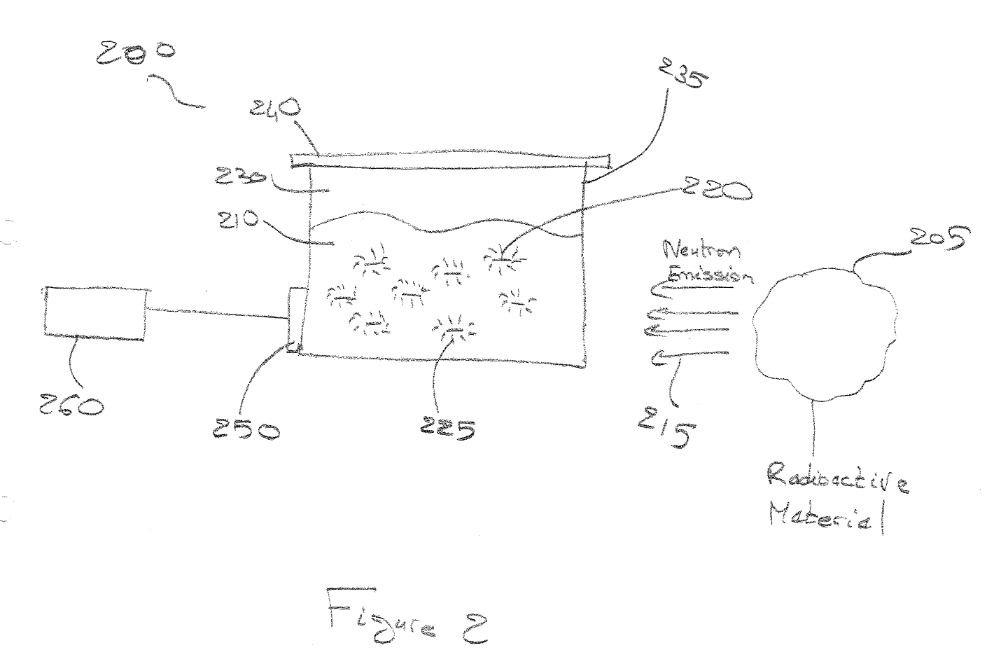

FIG. 2 is an illustration of a neutron detection system in operation using a Gadolinium-based neutron detector 200, according to various aspects of the current invention. In FIG. 2, the radioactive material 205 emits neutrons 215 that travel through the container 235, which is in close proximity to the radioactive material 205, the container 235 including the water medium 210 in which a dopant 225 is dissolved or dispersed. Accordingly, when the neutrons 215 coming from the radioactive material 205 collide with the dopant 220 that is dissolved or dispersed in the water medium 210, a capture reaction takes place, and as a result, beta particles are emitted. As the beta particles are emitted, the water medium 210 reacts with the beta particles and generates light 225 via the Cherenkov effect. According to various aspects, the light emitted through the Cherenkov effect generally has a spectrum of primarily Ultraviolet (UV) light extending into the blue section of the visible spectrum, and is created when an electron moves faster than the speed of light in that medium. This light can be detected by a light detector 250, which may include, for example, an array of photomultiplier tubes (PMTs) or a photodiode connected to an analog-to-digital converter (ADC) for data acquisition. According to various aspects, the light detector 250 may be located adjacent any portion of the container 235, sufficiently close and optimally positioned to collect a sufficient light signal. The data collected via the light detector 250 can then be transmitted to a controller 260 which may be specifically programmed to derive an amount of radioactivity based on the signal detected by the light detector 250. It should be noted that the Cherenkov effect typically has a threshold of around 2 MeV for Gamma photons, allowing near perfect matching of discrimination of a high energy active interrogation system when, for example, the Cherenkov effect is used solely for Gamma detection.

Using the Cherenkov effect is relatively inexpensive. Hence, the low cost of the detection according to aspects of the current invention allows for a coverage of a large detection area and a resulting higher efficiency that the existing more expensive methods. Furthermore, along with the cost effectiveness, a projector effect is exhibited by the Cherenkov effect, where the light released from high energy electrons produces a cone of radiation in the direction of the incident radiation. By using a high area photo-detection array, not only can the incident radiation be detected, but the radiation can also be tagged in such a way that source direction can be identified and the location of the source of neutrons, which is the radioactive material, can be determined in, for example, a cargo. This directionality represents an alternative to the current technology being developed for directional detection, which utilizes gamma and neutron pixel arrays. Accordingly, not only can radioactivity be determined, but the location of the radioactive material may also be determined.

According to various aspects, a wavelength shifter may also be used to receive the light emitted by the dopant via the Cherenkov effect, which may not be readily detectable by a photodiode or a photomultiplier tube (PMT), and to shift the wavelength of the received light to a spectrum of light that is more readily detected by the light detector 250, photodiode or PMT. Typically, the shifted light is in a wavelength range that fluoresces under a UV lamp and emits a blue light. According to various aspects, using a wavelength shifter may render the process more efficient.

According to various aspects, because the detector 200 may be susceptible to light and electrical noise, care should be taken that light and electrical leaks should be sealed from the container 235. It should be noted that the scalability of the Cherenkov detector 200 for neutron detection according to various aspects of the current invention, as the system described in FIGS. 1 and 2, may also allow for a variety of uses in applications at nuclear power facilities, medical facilities, and nuclear research facilities, as well as representing a novel detection technique for nuclear nonproliferation and homeland security applications. Using both small modular units connected in series as well as large multi-hundred liter tanks and high area cargo, scanning systems can be deployed at a significantly lower price than the technology that is currently available. The economy of detectors according to various aspects of the current invention may allow for large detection areas that bring significant improvements over the detection efficiency of, for example, Helium-3 detector arrays currently devised.

According to various aspects, a detector, or region of detector, may also be left un-doped, the signal from this area providing discrimination against non-neutron-radiation.

According to various aspects of the current invention, the above system and operation can be controlled and operated via hardware and software, as discussed in greater detail below.

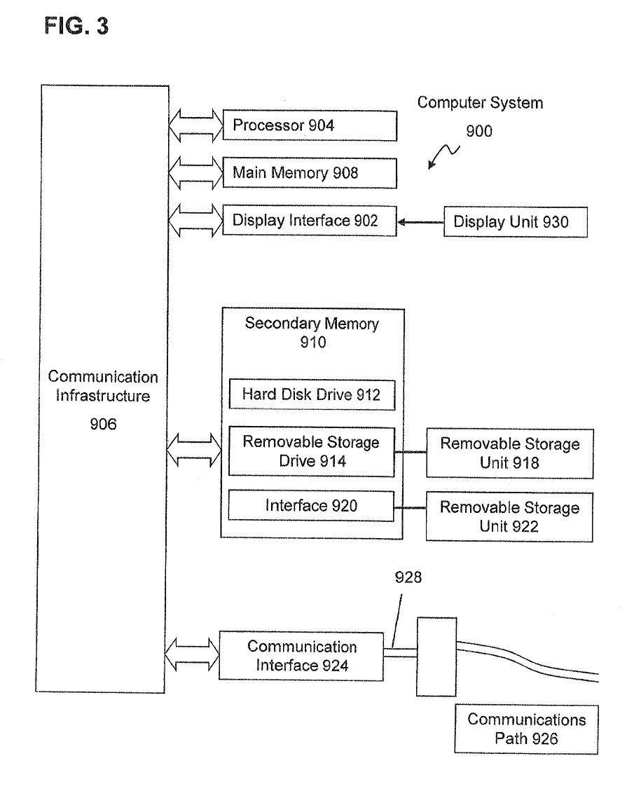

FIG. 3 presents an exemplary system diagram of various hardware components and other features, for use in accordance with an aspect of the present invention. The present invention may be implemented using hardware, software, or a combination thereof and may be implemented in one or more computer systems or other processing systems. In one aspect, the invention is directed toward one or more computer systems capable of carrying out the functionality described herein. An example of such a computer system 900 is shown in FIG. 3.

Computer system 900 includes one or more processors, such as processor 904. The processor 904 is connected to a communication infrastructure 906 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an aspect where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

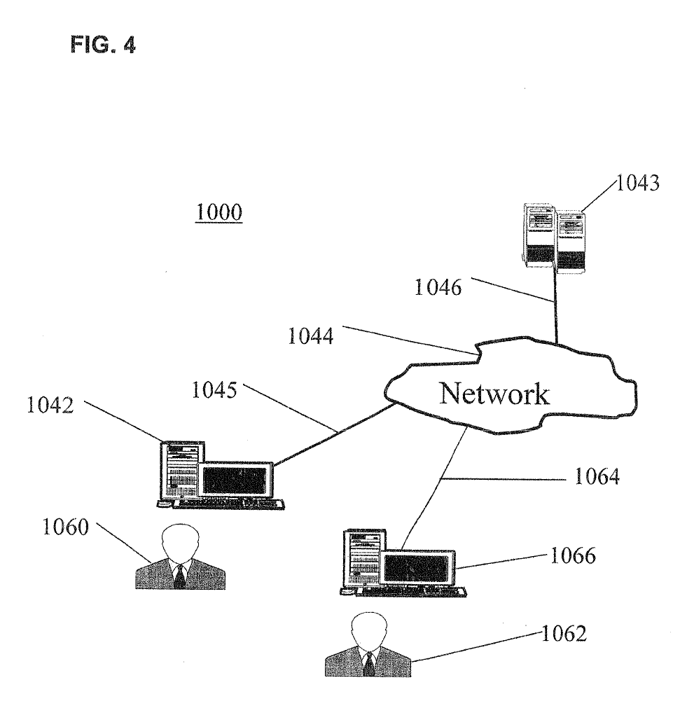

FIG. 4 is a block diagram of various exemplary system components, in accordance with an aspect of the present invention. FIG. 4 shows a communication system 1000 usable in accordance with the present invention. The communication system 1000 includes one or more accessors 1060, 1062 (also referred to interchangeably herein as one or more “users”) and one or more terminals 1042, 1066. In one aspect, data for use in accordance with the present invention is, for example, input and/or accessed by accessors 1060, 1064 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another aspect, the method and system of the present invention operate in a stand-alone environment, such as on a single terminal.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A neutron detector system, comprising:
a container comprising a fluid, the fluid comprising a dopant that reacts with beta particles, wherein, in the presence of a radioactive material, a reaction takes place between the dopant and the radioactive material; and
a detector that detects the reaction between the dopant and the radioactive material.

2. The system of claim 1, wherein the dopant comprises at least one of:
a high neutron capture cross-section;
a detectable neutron capture reaction;
a high solubility in the fluid; and
a low reactivity with other metals.

3. The system of claim 1, further comprising an inert gas in the container that prevents at least one of the fluid and the dopant from undergoing one or more unwanted reactions.

4. The system of claim 1, wherein the dopant comprises Gadolinium Chloride.

5. The system of claim 4, wherein a concentration of Gadolinium Chloride in the fluid is about 0.1%.

6. The system of claim 1, wherein the fluid comprises deionized water.

7. The system of claim 1, wherein the container is hermetically sealed to prevent at least one of the fluid, the dopant and the container from undergoing one or more unwanted reactions.

8. The system of claim 1, wherein the reaction between the dopant and the radioactive material comprises a reaction between the dopant and one or more neutrons emitted by the radioactive material.

9. The system of claim 1, wherein the reaction between the dopant and the radioactive material creates light via a Cherenkov effect.

10. The system of claim 1, wherein the detector comprises a light detector.

11. The system of claim 1, wherein an inner surface of the container is coated with a corrosion-resistant coating.

12. The system of claim 2, wherein the dopant has a probability of absorbing a neutron of up to 50,000 barns.

13. The system of claim 1, wherein the container is a steel drum.

14. The system of claim 10, wherein the light detector comprises at least one or more photomultiplier tubers and one or more photodiodes.

15. A neutron detector method, comprising:
providing a container with a fluid;
providing a dopant in the fluid, the dopant being capable of reacting with beta particles emitted by a radioactive material; and
detecting a signal generated by a reaction between the dopant and the beta particles of the radioactive material.

16. The method of claim 15, further comprising determining a location of the radioactive material based on a cone of radiation generated by the detected signal.

17. The method of claim 14, wherein the detected signal is a light signal.

18. The method of claim 15, further comprising:
providing the dopant and the fluid in a container;
adding an inert gas to the container; and
sealing the container to prevent at least one of the fluid and the dopant from undergoing one or more unwanted reactions.

19. A neutron detector system, the system comprising:
a processor;
a user interface functioning via the processor; and
a repository accessible by the processor; wherein
a container is provided with a fluid;
a dopant is provided in the fluid, the dopant being capable of reacting with beta particles emitted by a radioactive material; and
a signal generated by a reaction between the dopant and the beta particles of radioactive material is detected via the processor.

20. A computer program product comprising a non-transitory computer usable medium having control logic stored therein for causing a computer to exchange user-generated community information, the control logic comprising:
computer readable program code means for detecting a signal generated by a reaction between a dopant dispersed in a fluid and beta particles emitted by a radioactive material; and
computer readable program code means for detecting a radioactivity of the radioactive material based on the detected signal.
